(19) United States
(12) Patent Application Publication
(10) Pub. No.: US 2013/0112452 A1
(43) Pub. Date: May 9, 2013

(54) Whizer a rechargable rotating power tool and padded attachment with multi purpose covers

(71) Applicant: George William Skopis, Glenview, IL (US)

(72) Inventor: George William Skopis, Glenview, IL (US)

(21) Appl. No.: 13/694,034

(22) Filed: Dec. 7, 2012

Related U.S. Application Data
(60) Provisional application No. 61/555,850, filed on Nov. 4, 2011.

(51) Int. Cl. B25F 5/00

(52) U.S. Cl. CPC B25F 5/00
USPC 173/217

(57) ABSTRACT

A portable, hand held, electric, re-chargeable, rotating power tool, with three different size affixable heads and assorted covers used to complete tasks.

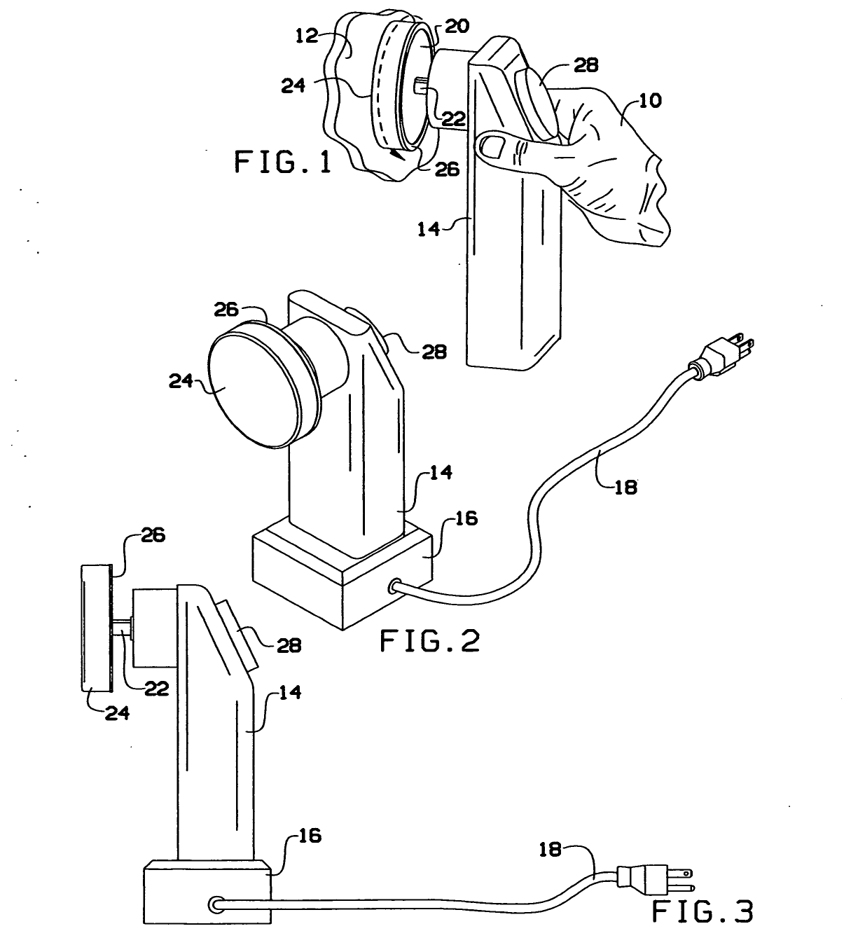

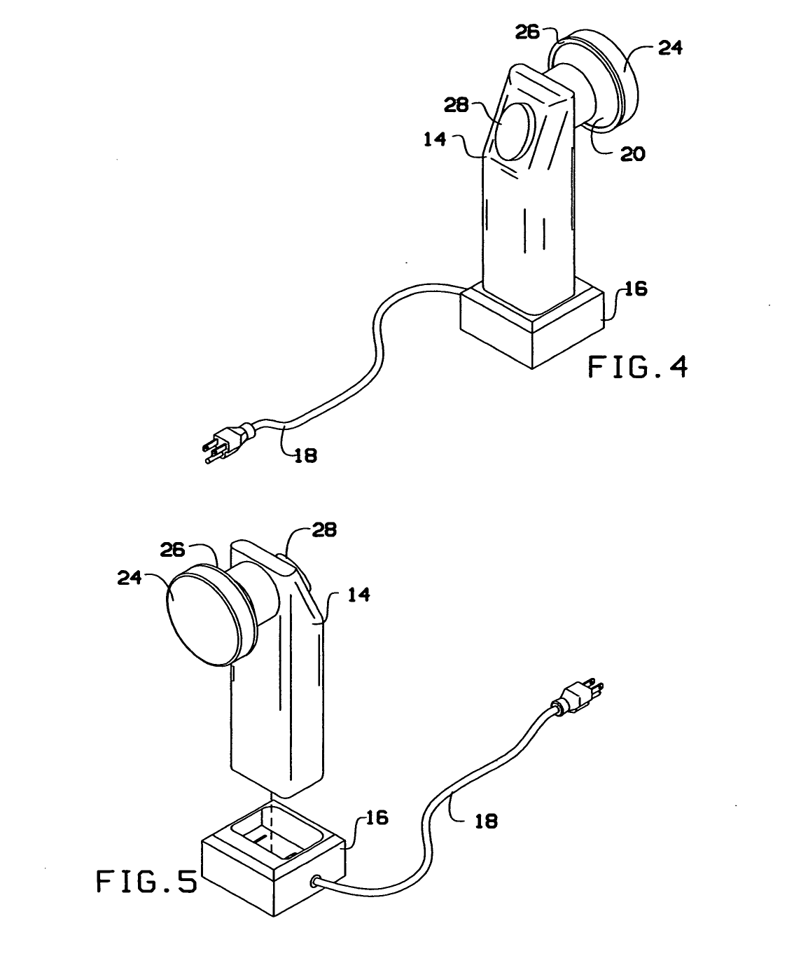

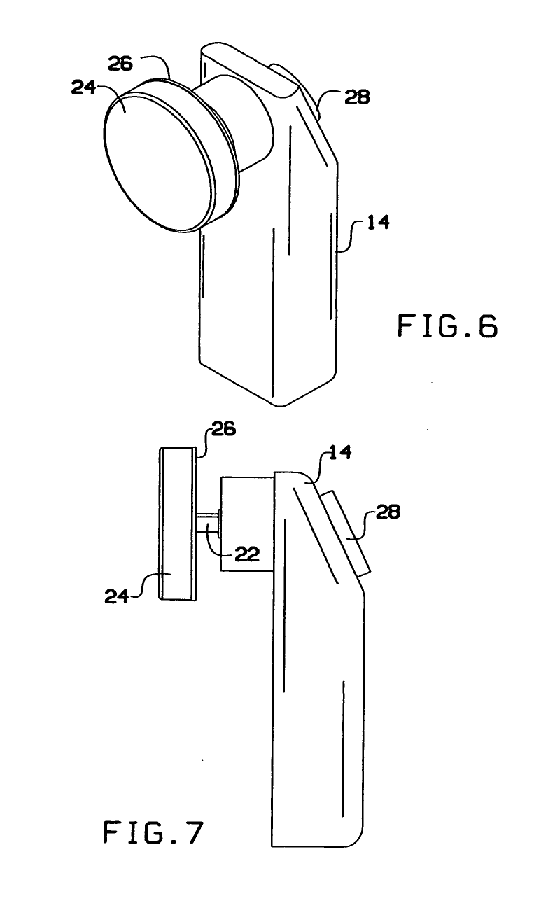

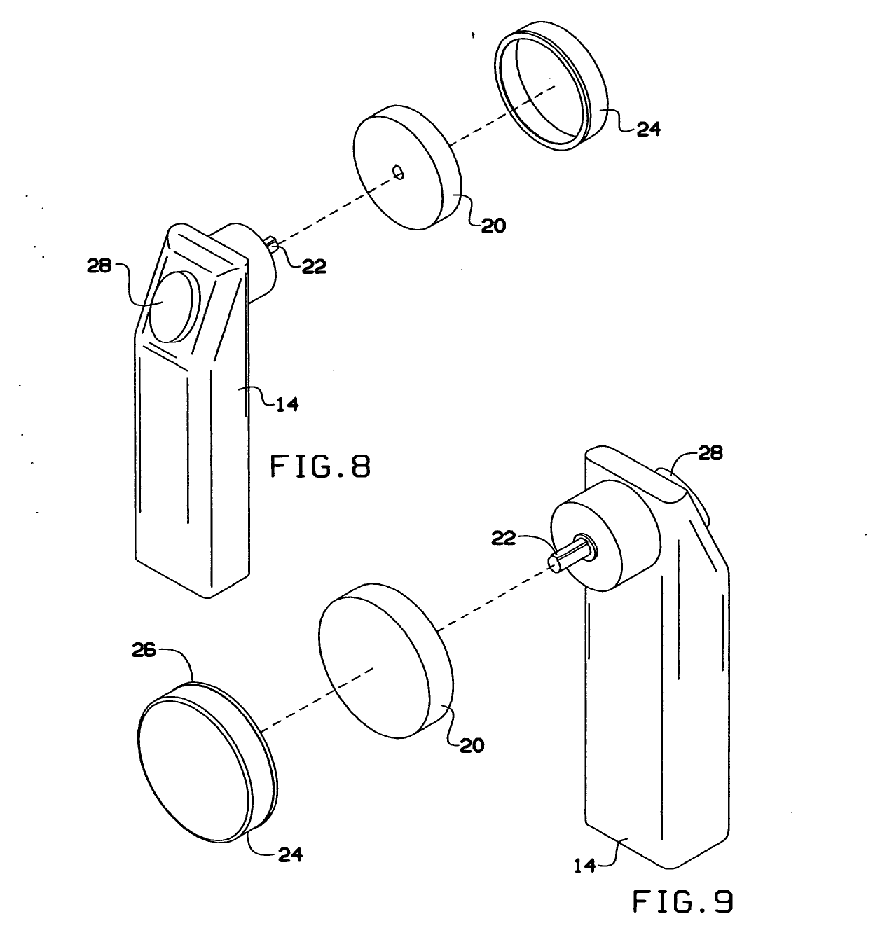

### BACKGROUND OF THE INVENTION

### Problem Solved

The amount of time, physical exertion and depth spent on cleaning all types of surfaces. Other tools, lack convex heads, cleaning covers and different sizes for different jobs.

### DETAILED DESCRIPTION OF THE INVENTION

By attaching the “Whizer Cleaner” power head attachment to the tool or any electrical rotating device such as electrical or battery operated drill, cleaning time, physical exertion, and depth of cleaning are better managed. The “Whizer Cleaner” has three, a small, medium and large, convex head attachment, with covers that are better suited for a variety of power utilized tasks. Others, do not come in different sizes, nor are they convex in design, and don't have the different cleaning covers.

### The Version Discussed Here

A circular, convex rubber pad with an attached external foam rubber type softer pad and a centered metal attached covered axle for affixing to the tool or to a common drill or rotational motor. There are three different attachable head sizes, small, medium and large, with assorted covers for the tasks at hand.

### Relationship Between the Components

(1) Attach “Whizer Cleaner” to (2) the electrical rotating tool or an electric drill. (3) Affix appropriate cover for task.

### How The Invention Works

Attach the “Whizer Cleaner” to the portable, re-chargeable, electric rotating tool or any drill, and place the appropriate cover on the tool head for the job or task at hand. Activate the power source.

### How to Make the Invention

Affix a centered axle, to a larger convex, harder rubber inner piece, that has a softer foam type rubber outer attached piece, that accommodates the appropriate cover to complete the task at hand. Attach the head and cover to the portable, electric re-chargeable, rotating power tool for completion.

### How to Use the Invention

Attach the selected size head and cover to the “Whizer Cleaner” power tool or any electrical rotating device. Turn the power source on and begin the task or job at hand. Additionally, with different head covers, it can sand, wax, buff and grind.

1. A portable, rechargeable, hand held electric power rotating device, with attachable convex padded cleaning heads and covers, for scrubbing, sanding, polishing, waxing and cleaning tasks.
